(19) United States
(12) Patent Application Publication
(10) Pub. No.: US 2026/0172404 A1
(43) Pub. Date: Jun. 18, 2026

(54) METHOD AND DEVICE FOR CONNECTING VEHICLE TO EXTERNAL DEVICE

(71) Applicants: HYUNDAI MOTOR COMPANY, Seocho-gu (KR); Kia Corporation, Seocho-gu (KR)

(72) Inventor: Dong Ok KIM, Gyeonggi-do (KR)

(21) Appl. No.: 19/417,928

(22) Filed: Dec. 12, 2025

(30) Foreign Application Priority Data
Dec. 12, 2024 (KR) 10-2024-0184334

(51) Int. Cl. H04L 9/40

(52) U.S. Cl. CPC H04L 63/0428

(57) ABSTRACT

Connecting a vehicle to an external device, performed by a computing device implemented in the vehicle and including a processor, a memory device and a communication interface, includes receiving an external device access notification indicating that access of the external device has occurred through a gateway in the vehicle, transmitting a connection approval request requesting approval of connection of the external device to the server, receiving a connection approval response approving the connection of the external device from the server, and transmitting an external device connection process request that allows connection of the external device to the gateway in response to the connection approval response.

### CROSS-REFERENCE TO RELATED APPLICATION

Pursuant to 35 U.S.C. § 119(a), this application claims the benefit of an earlier filing date and right of priority to Korean Patent Application No. 10-2024-0184334 filed at the Korean Intellectual Property Office on Dec. 12, 2024, the entire contents of which are incorporated herein by reference.

### TECHNICAL FIELD

The present disclosure relates to connecting a vehicle to an external device.

### BACKGROUND

To enhance security, vehicles can restrict access to vehicle data based on encrypted keys. In such cases, it can be difficult to access the data inside the vehicle without the encrypted key. For a controller area network (CAN) adopting a BUS structure, vehicle data can be accessed relatively easily as long as a physical connection is made. As such, some specialized devices can acquire vehicle data by physically connecting directly to the CAN.

In scenarios where the vehicle network is Ethernet-based, data security is further enhanced. Vehicle data cannot be accessed through a physical connection alone, and data can only be acquired through an Ethernet switch that controls communication within the network. In such scenarios, additional security measures are implemented to protect access to vehicle data by external devices. However, these additional security measures can increase complexity, thus creating a need for techniques that can reduce unnecessary complexity in the process of exchanging data between external devices and a vehicle, and to increase user convenience and efficiency in the process of exchanging data

### SUMMARY

A method for connecting a vehicle to an external device according to an implementation, performed by a computing device implemented in the vehicle and including a processor, a memory device, and a communication interface, includes the processor receiving an external device access notification indicating that access of the external device has occurred through a gateway in the vehicle, the processor transmitting a connection approval request requesting approval of connection of the external device to the server, the processor receiving a connection approval response approving the connection of the external device from the server, and the processor transmitting an external device connection process request that allows connection of the external device to the gateway in response to the connection approval response.

In some implementations, the connection approval response can be generated by being approved by a user terminal in response to the connection approval request received from the server.

In some implementations, the external device access notification received from the gateway and the external device connection process request transmitted to the gateway can be implemented through an Ethernet packet to which media access control security (MACsec) is applied.

In some implementations, the Ethernet packet can include a security tag (SecTAG) field and an integrity check value (ICV) field.

In some implementations, the user terminal can display a user interface for receiving input from the user to allow connection of the external device, and the connection approval response can be transmitted from the user terminal to the server when input is completed from the user through the user interface.

In some implementations, the method can further include the processor receiving a vehicle information connection permission request requesting connection permission for vehicle information of the external device through the gateway, the processor transmitting a permission approval request requesting approval of permission of the external device to the server, the processor receiving a permission approval response approving the permission of the external device from the server, and the processor providing vehicle data to the external device through the gateway in response to the permission approval response.

In some implementations, the permission approval response can be generated by being approved by the user terminal in response to the permission approval request received from the server.

In some implementations, the vehicle information connection permission request received from the gateway and the vehicle data transmitted to the gateway can be implemented through the Ethernet packet to which media access control security (MACsec) is applied.

In some implementations, the user terminal can display the user interface for receiving input allowing the permission of the external device from the user, and the permission approval response can be transmitted from the user terminal to the server when input is completed from the user through the user interface.

In some implementations, the method can further include the processor receiving the vehicle information connection permission request requesting connection permission for vehicle information of the external device through the gateway, and the processor providing vehicle data to the external device through the gateway.

In some implementations, the vehicle information connection permission request transmitted from the external device to the gateway and the vehicle data transmitted from the gateway to the external device can be implemented through the Ethernet packet to which transport layer security (TLS) is applied.

In some implementations, the Ethernet packet can include a TLS field.

A device for connecting a vehicle to an external device according to an implementation implemented in a vehicle includes a communication interface, one or more non-transitory computer-readable media including instructions, and one or more processors executing the instructions to perform an operation, wherein the operation can include receiving an external device access notification indicating that access of the external device has occurred through a gateway in the vehicle, transmitting a connection approval request requesting approval of connection of the external device to a server, receiving a connection approval response approving the connection of the external device from the server, and transmitting an external device connection process request that allows connection of the external device to the gateway in response to the connection approval response.

In some implementations, the connection approval response can be generated by being approved by a user terminal in response to the connection approval request received from the server.

In some implementations, the external device access notification received from the gateway and the external device connection process request transmitted to the gateway can be implemented through an Ethernet packet to which media access control security (MACsec) is applied.

In some implementations, the operation can further include receiving the vehicle information connection permission request requesting connection permission for vehicle information of the external device through the gateway, transmitting a permission approval request requesting approval of permission of the external device to the server, receiving a permission approval response approving the permission of the external device from the server, and providing vehicle data to the external device through the gateway in response to the permission approval response.

In some implementations, the permission approval response can be generated by being approved by the user terminal in response to the permission approval request received from the server.

In some implementations, the operation can further include receiving the vehicle information connection permission request requesting connection permission for vehicle information of the external device through the gateway, and the processor providing vehicle data to the external device through the gateway in response to the permission approval response.

In some implementations, the vehicle information connection permission request transmitted from the external device to the gateway and the vehicle data transmitted from the gateway to the external device can be implemented through the Ethernet packet to which transport layer security (TLS) is applied.

In one or more non-transitory computer-readable media according to an implementation, including instructions executable by a computing device including a communication interface, the instructions allow the computing device to perform an operation when executed by one or more processors of the computing device, wherein the operation includes receiving an external device access notification indicating that access of the external device has occurred through a gateway in the vehicle, transmitting a connection approval request requesting approval of connection of the external device to a server, receiving a connection approval response approving the connection of the external device from the server, and transmitting an external device connection process request that allows connection of the external device to the gateway in response to the connection approval response.

### BRIEF DESCRIPTION OF THE DRAWINGS

FIG. 1 is a drawing for describing an example of a device for connecting a vehicle to an external device according to an implementation.

FIG. 2 is a drawing for describing an example of an operation of the device for connecting the vehicle to the external device according to an implementation.

FIG. 3 is a drawing for describing an example of a method for connecting the vehicle to the external device according to an implementation.

FIG. 4 is a drawing for describing an implementation example of the method and the device for connecting the vehicle to the external device according to an implementation.

FIG. 5 is a drawing for describing an example of the method for connecting the vehicle to the external device according to an implementation.

FIG. 6 is a drawing for describing an implementation example of the method and the device for connecting the vehicle to the external device according to an implementation.

FIG. 7 is a drawing for describing an implementation example of the method and the device for connecting the vehicle to the external device according to an implementation.

FIG. 8 is a drawing for describing an example of a computing device according to an implementation.

### DETAILED DESCRIPTION

In scenarios where a vehicle network, such as an in-vehicle network, is Ethernet-based, security for vehicle data can be provided by using Media Access Control Security (MACsec) technology, as specified in the IEEE 802.1AE standard. MACsec provides authentication at the data link layer by ensuring that only approved devices are allowed to communicate on the vehicle network, and data acquisition is fundamentally blocked if a vehicle controller does not allow access to external devices.

In such scenarios, even if vehicle manufacturers allow external devices to access data, the external devices must go through a complex security process. In some cases, the complex security process can be required for each instance the external device attempts to access vehicle data. Although this approach increases security, it can cause unnecessary complexity in the data exchange process between authorized external devices and the vehicle.

Implementations disclosed herein can provide reduced complexity for secure data exchange between the vehicle controller and the external device. In some implementations, the vehicle network utilizes Transport Layer Security (TLS) to provide transport layer protection, omitting complex security procedures and performing secure authentication, provided that the external device is approved and agreed upon by the vehicle manufacturer.

As such, the present disclosure provides a method and a device for connecting a vehicle to an external device that can help provide convenience in the process of exchanging data between an approved external device and a vehicle in an Ethernet-based vehicle network.

The present disclosure will be described in detail hereinafter with reference to the accompanying drawings, in which implementations of the present disclosure are shown. As those skilled in the art would realize, the described implementations can be modified in various different ways, all without departing from the spirit or scope of the present disclosure. The drawings and description are to be regarded as illustrative in nature and not restrictive, and like reference numerals designate like elements throughout the specification.

In addition, unless explicitly stated to the contrary, the word “comprise” and variations such as “comprises” and “comprising” should be understood to imply the inclusion of stated elements but not the exclusion of any other elements. Although the terms “first,” “second,” and the like are used to explain various components, the components are not limited to such terms. These terms are only used to distinguish one component from another component.

Terms written in the present specification such as “unit,” “module” and the like indicate a unit processing at least one or more functions or operations, and these functions or operations can be implemented by hardware or a circuit, software, or a combination of hardware or a circuit and software. Additionally, at least some of the configurations or functions of a method and a device for connecting a vehicle to an external device according to the implementations described below can be implemented as a program or software, and the program or software can be stored in a computer-readable medium.

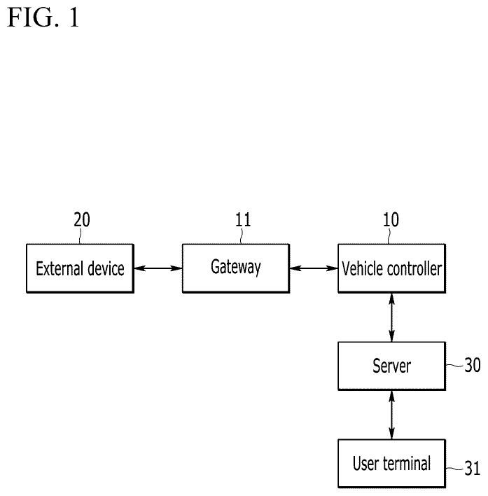

FIG. 1 is a drawing for describing a device for connecting a vehicle to an external device according to an implementation.

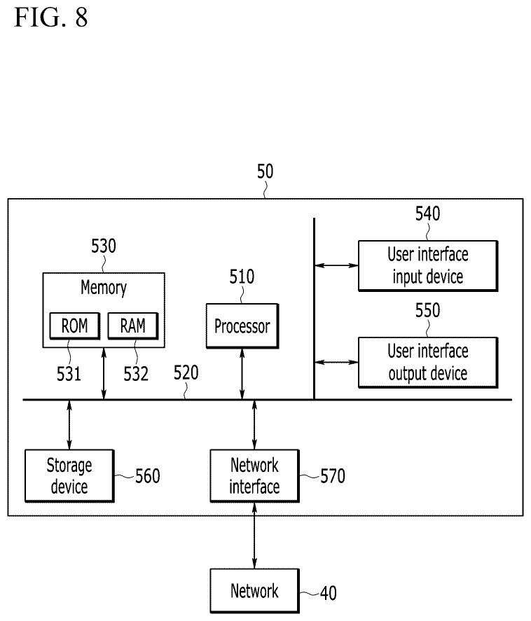

Referring to FIG. 1, the device for connecting the vehicle to the external device according to an implementation can be implemented as a computing device including a processor and a memory. For example, the device for connecting the vehicle to the external device can be implemented with a computing device (e.g., computing device 50 as described below with reference to FIG. 8). Here, the computing device 50 can be implemented in a vehicle—for example, as a vehicle controller 10 mounted on the vehicle. For example, with reference to FIG. 8, the processor can correspond to a processor 510 of the computing device 50, and the memory can correspond to a memory 530 of the computing device 50. Alternatively, in some implementations, the vehicle controller 10 can include one or more non-transitory computer-readable media including instructions and one or more processors executing the instructions to perform an operation. Here, the operation can include the configuration, function, step, etc. described in this specification with respect to a method and a device for connecting a vehicle to an external device according to the implementations.

The vehicle controller 10 can be implemented within the vehicle. The vehicle controller 10 can exchange data with other devices or sensors, such as a gateway 11 implemented together within the vehicle. In some implementations, the internal network can include a controller area network (CAN), a local interconnect network (LIN), and an automotive ethernet. In some implementations, the vehicle controller 10 can exchange data with a server 30 and a user terminal 31 (e.g., a smart phone) via a network (e.g., network 40 in FIG. 8). The network 40 can include a wireless network, which can be implemented with, for example, a cellular network, a WiFi network, etc.

The vehicle controller 10 can perform operations, examples of which are described below, to reduce unnecessary complexity in the process of exchanging data between an approved external device and a vehicle, and to increase user convenience and efficiency in the process of exchanging data.

When an external device 20 attempts to access vehicle data, the vehicle controller 10 can receive a notification through the gateway 11 in the vehicle, such as an external device access notification, indicating that access of the external device has occurred. The external device access notification can be a result of the external device 20 activating the network through an activation line of diagnostic over internet protocol (DoIP), and in response, the gateway 11 generates the notification and transmits the notification to the vehicle controller 10. The activation line can be used to activate the DoIP network in a vehicle diagnostic process—for example, when the external device 20 (e.g., a vehicle diagnostic device) is connected to the vehicle, in which case the activation line can activate the network via a specific signal, such as a voltage or a CAN signal. The gateway 11 can detect a diagnostic request from the external device 20 through the activation line and configure a network by activating an electronic control unit (ECU) and modules required for the diagnostic work.

After receiving the external device access notification, the vehicle controller 10 can transmit to the server 30 a connection approval request, requesting approval of the connection of the external device 20. The vehicle controller 10 can then receive from the server 30 a connection approval response, approving the connection of the external device 20. In some implementations, the connection approval response can be generated by the server 30 based on approval by the user terminal 31 in response to a connection approval request received from the server 30. For example, after the network is activated through the DoIP activation line, the vehicle controller 10 can transmit the connection approval request to the user terminal 31, e.g., via the server 30. In response, the connection approval response can be transmitted from the user terminal 31 to the vehicle controller 10, e.g., via the server 30. The response from the user terminal 31 can be, for example, based on an input or other data reflecting the intention of the authorized vehicle owner.

For example, in some implementations, a user interface can be displayed on the user terminal 31 to receive input from a user—for example, the authorized vehicle owner—to allow connection of the external device 20, and upon completion of the input from the user through the user interface, the connection approval response can be transmitted from the user terminal 31 to the server 30 when input is completed from the user through the user interface.

After receiving the connection approval response, the vehicle controller 10 can transmit an external device connection process request to the gateway 11, which allows connection of the external device 20 to the gateway 11. Accordingly, connection of the external device 20 can be permitted.

In some implementations, both the external device access notification received from the gateway 11 and the external device connection process request transmitted to the gateway 11 can be implemented through an Ethernet packet to which media access control security (MACsec) is applied. MACsec is a security protocol designed according to the IEEE 802.1AE standard to protect network traffic at the data link layer, which adds security tags to data packets to ensure that transmitted and received data is communicated only between authenticated devices. Applying the MACsec to the vehicle's Ethernet network can provide a high level of security, as external devices cannot access the network unless they are authenticated with an encrypted key. For example, the Ethernet packet can include a security tag (SecTAG) field and an integrity check value (ICV) field.

After the connection of the external device 20 is completed, the vehicle controller 10 can receive through the gateway 11 a vehicle information connection permission request, requesting connection permission to access vehicle information by the external device 20. In this case, there can be a difference in the connection procedure for vehicle information when the external device 20 is a diagnostic device and when the external device 20 is another device that is not a diagnostic device.

If the external device 20 is a diagnostic device, after receiving the vehicle information connection permission request, the vehicle controller 10 can transmit to the server 30 a permission approval request, requesting approval of the vehicle information connection permission request that was received from the external device 20. The vehicle controller 10 can then receive from the server 30 a permission approval response, approving the permission for the external device 20. In some implementations, the permission approval response can be generated based on approval by the user terminal 31 in response to the permission approval request received from the server 30.

For example, the user terminal 31 can display a user interface for receiving input allowing the permission of the external device 20 from the user—for example, the authorized vehicle owner. The permission approval response can be transmitted from the user terminal 31 to the server 30 when input is completed by the user through the user interface.

After receiving the permission approval response, the vehicle controller 10 can provide vehicle data to the external device 20 through the gateway 11, in response to the permission approval response.

The vehicle information connection permission request received from the gateway 11 and the vehicle data transmitted to the gateway 11 can be implemented through the Ethernet packet to which MACsec is applied. For example, the Ethernet packet can include the SecTAG field and the ICV field.

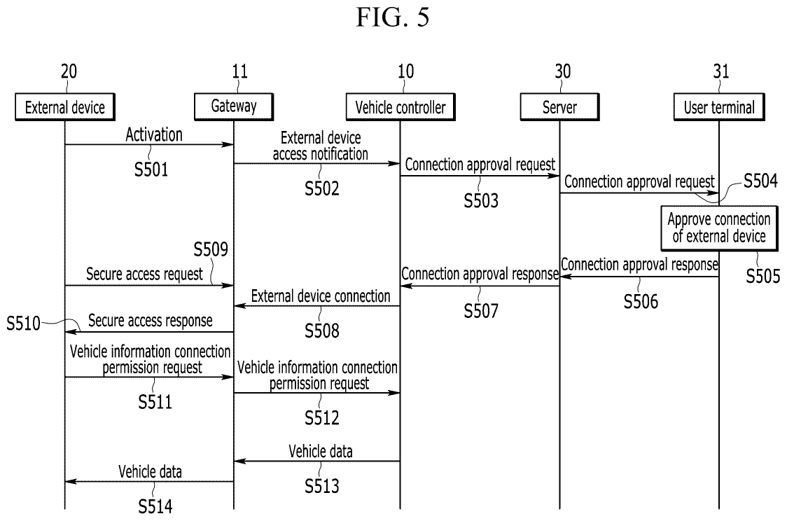

In contrast to the above scenario, if the external device 20 is not a diagnostic device, then after receiving the vehicle information connection permission request, the vehicle controller 10 can provide vehicle data to the external device 20 through the gateway without transmitting a request to the server 30. As described with reference to FIG. 5, this can help reduce complexity by streamlining the authentication and security process.

In some implementations, both the vehicle information connection permission request transmitted from the external device 20 to the gateway 11 and the vehicle data transmitted from the gateway 11 to the external device 20 can be implemented through the Ethernet packet to which Transport Layer Security (TLS) is applied. TLS is a transport-layer encryption protocol that encrypts data communication between a client and a server, using a handshake process to exchange encryption keys between the client and the server before communication begins, and using a certificate to verify the trust relationship. For example, the Ethernet packet can include a TLS field.

As such, it is possible to provide the convenience of data exchange between the approved external device and the vehicle in an Ethernet-based vehicle network through user approval and security authentication procedures.

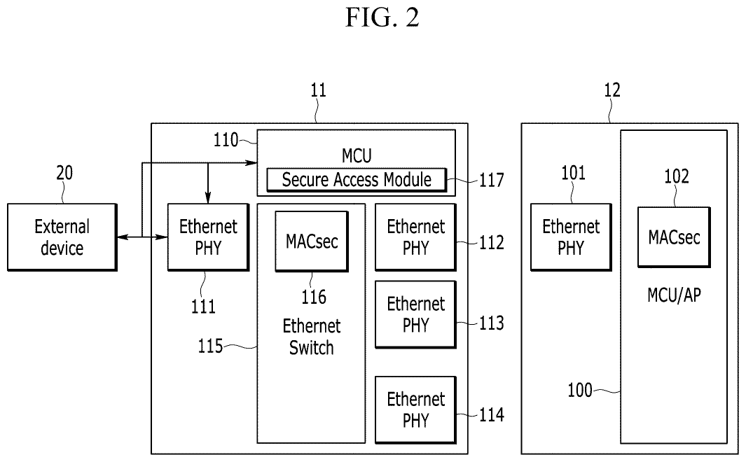

FIG. 2 is a drawing for describing an operation of the device for connecting the vehicle to the external device according to an implementation.

Referring to FIG. 2, the gateway 11 can include a microcontroller unit (MCU) 110 including a secure access module 117, an Ethernet switch 115 including Ethernet physical interfaces (Ethernet PHYs) 111, 112, 113, and 114 including a MACsec module 116. In some implementations, the vehicle can include other controllers, such as controller 12. In this case, the other controller 12 in the vehicle can also include an MCU 110 including a MACsec module 102 and an Ethernet physical interface 101. The external device 20, the MCU 110, and the Ethernet physical interface 111 can perform operations on the activation line defined in the DoIP standard.

When the activation line and Ethernet physical interface 111 are activated, the external device 20 can access the MCU 110 of the gateway 11 and perform secure access according to the procedures according to the implementations. After the secure access is successfully performed, the external device 20 can access other controllers within the vehicle, such as controller 12.

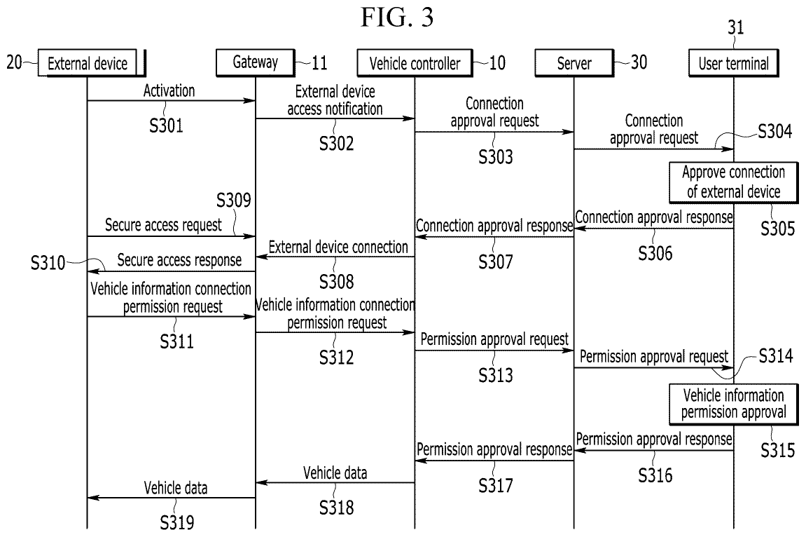

FIG. 3 is a drawing for describing a method for connecting the vehicle to the external device according to an implementation. This example illustrates a scenario where the external device 20 is a diagnostic device. In such scenarios, after receiving the vehicle information connection permission request, the vehicle controller 10 transmits a request to the server 30, in order to provide vehicle data to the external device 20.

Referring to FIG. 3, the method for connecting the vehicle to the external device according to an implementation of the present disclosure can include: in step (S301), a network can be activated through an activation line by the external device 20; and in step (S302), the gateway 11 can transmit the external device access notification to the vehicle controller 10 indicating that access of the external device has occurred. After receiving the external device access notification, the vehicle controller 10 can transmit to the server 30 the connection approval request, requesting approval of the connection of the external device 20 in step (S303). In step (S304), the server 30 can transmit the connection approval request to the user terminal 31, and in step (S305), the user terminal 31 can determine approval of the connection of the external device 20, for example according to the intention of the authorized vehicle owner. Thereafter, in step (S306), the user terminal 31 can transmit the connection approval response approving the connection of the external device 20 to the server 30, and in step (S307), the server 30 can transmit the connection approval response to the vehicle controller 10. After receiving the connection approval response, in step (S308), the vehicle controller 10 can transmit to the gateway 11 the external device connection process request, which allows connection of the external device 20. Accordingly, the external device 20 can be authorized for secure access through steps (S309, S310).

Here, the external device access notification received from the gateway 11 (S302) and the external device connection process request transmitted to the gateway 11 (S308) can be implemented through the Ethernet packet to which MACsec is applied.

If the external device 20 is a diagnostic device, then after the connection of the external device 20 is completed, in step (S311), the external device 20 can transmit the vehicle information connection permission request to the gateway 11, and in step (S312), the gateway 11 can transmit the vehicle information connection permission request to the vehicle controller 10. After receiving the vehicle information connection permission request, the vehicle controller 10 can transmit to the server 30 the permission approval request, requesting approval of the permission for the external device 20 in step (S313). In step (S314), the server 30 can transmit the permission approval request to the user terminal 31, and in step (S315), the user terminal 31 can determine to approve permission for vehicle information of the external device 20, e.g., according to the intention of the authorized vehicle owner. Thereafter, in step (S316), the user terminal 31 can transmit to the server 30 the permission approval response approving the permission for vehicle information of the external device 20, and in step (S317), the server 30 can transmit the permission approval response to the vehicle controller 10. After receiving the permission approval response, the vehicle controller 10 can provide vehicle data to the external device 20 through the gateway 11 in steps (S318) and (S319).

Both the vehicle information connection permission request received from the gateway 11 (S312) and vehicle data transmitted to the gateway 11 (S318) can be implemented through the Ethernet packet to which MACsec is applied.

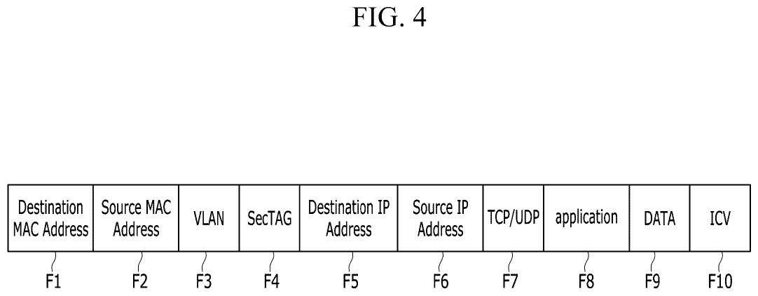

FIG. 4 is a drawing for describing an implementation example of the method and the device for connecting the vehicle to the external device according to an implementation.

Referring to FIG. 4, an example of the Ethernet packet with MACsec applied is illustrated. A first field F1 and a second field F2 can be physical addresses that identify the destination and source of data, a third field F3 can be a tag for logically separating the network, a fourth field F4 can be a SecTAG tag for MACsec security, a fifth field F5 and a sixth field F6 can be IP addresses that designate the destination and source of a network layer of data, a seventh field F7 can be a TCP/UDP transmission layer protocol that manages a transmission method and connection of data, an eighth field F8 can designate an application program to which the data belongs, a ninth field F9 can be the actual transmitted content, and a tenth field F10 can be a value for verifying data integrity.

FIG. 5 is a drawing for describing the method for connecting the vehicle to the external device according to an implementation. For example, this example can apply to a scenario where the external device 20 is not a diagnostic device. The steps for establishing a connection of the external device 20 are similar to those in FIG. 3. However, different from FIG. 3, after the connection has been established (in S508), the vehicle controller 10 can thereafter provide vehicle data to the external device 20 through the gateway 11 without transmitting a request to the server 30.

Referring to FIG. 5, the method for connecting the vehicle to the external device according to an implementation of the present disclosure can include: in step (S501), a network can be activated through an activation line by the external device 20; and in step (S502), the gateway 11 can transmit the external device access notification to the vehicle controller 10 indicating that access of the external device has occurred. After receiving the external device access notification, the vehicle controller 10 can transmit to the server 30 the connection approval request, requesting approval of the connection for the external device 20 in step (S503). In step (S504), the server 30 can transmit the connection approval request to the user terminal 31, and in step (S505), the user terminal 31 can determine to approve the connection of the external device 20, e.g., according to the intention of the authorized vehicle owner. Thereafter, in step (S506), the user terminal 31 can transmit the connection approval response approving the connection of the external device 20 to the server 30, and in step (S507), the server 30 can transmit the connection approval response to the vehicle controller 10. After receiving the connection approval response, the vehicle controller 10 can transmit to the gateway 11 the external device connection process request, which allows connection of the external device 20 in step (S508). Accordingly, the external device 20 can be authorized for secure access through steps (S509) and (S510).

Here, both the external device access notification received from the gateway 11 (S502) and the external device connection process request transmitted to the gateway 11 (S508) can be implemented through the Ethernet packet to which MACsec is applied.

If the external device 20 is not a diagnostic device, after the connection of the external device 20 is completed, then subsequently in step (S511) the external device 20 can transmit the vehicle information connection permission request to the gateway 11, and in step (S512) the gateway 11 can transmit the vehicle information connection permission request to the vehicle controller 10. After receiving the permission approval response, the vehicle controller 10 can provide vehicle data to the external device 20 through the gateway 11 in steps (S513) and (S514).

In this scenario, for example, the complexity of the MACsec security process in the vehicle network (e.g., between the gateway 11 and vehicle controller 10) can be avoided when providing the vehicle data in steps (S513) and (S514). Security and authentication can be provided between the external device 20 and the gateway 11 by using the TLS protocol. For example, both the vehicle information connection permission request transmitted from the external device 20 to the gateway 11 (S512) and the vehicle data transmitted from the gateway 11 to the external device 20 (S513) can be implemented through the Ethernet packet to which TLS is applied.

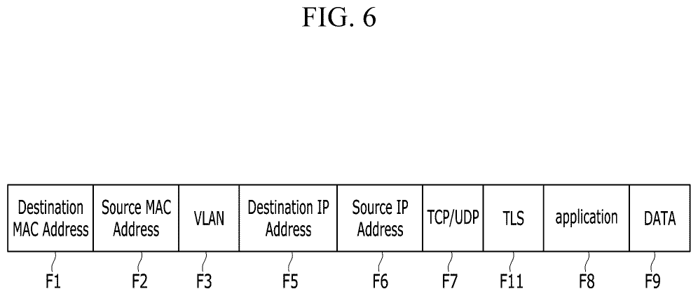

FIG. 6 is a drawing for describing an implementation example of the method and the device for connecting the vehicle to the external device according to an implementation.

Referring to FIG. 6, an example of an Ethernet packet with TLS applied is illustrated. The first field F1 and the second field F2 can be physical addresses that identify the destination and source of data, the third field F3 is a tag for logically separating the network, the fifth field F5 and the sixth field F6 can be IP addresses that designate the destination and source of the network layer of data, the seventh field F7 can be the TCP/UDP transmission layer protocol that manages a transmission method and connection of data, an eleventh field F11 can provide encryption and authentication of application layer data, the eighth field F8 can designate an application program to which the data belongs, and the ninth field F9 can be the actual transmitted content.

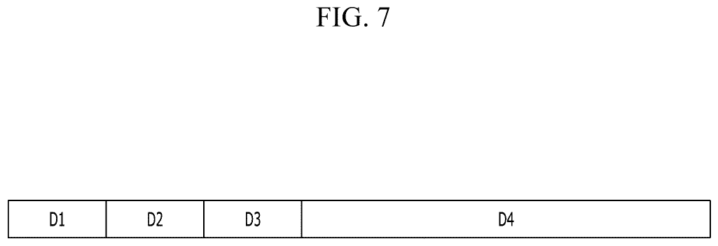

FIG. 7 is a drawing for describing an implementation example of the method and the device for connecting the vehicle to the external device according to an implementation.

Referring to FIG. 7, an example of a DATA field of the Ethernet packet can include a D1 field, a D2 field, a D3 field, and a D4 field as illustrated. Here, the DATA field can correspond to the ninth field F9 described above with respect to FIG. 4 or FIG. 6.

The D1 field can indicate whether the external device 20 is a diagnostic device or a special device (non-diagnostic device). For example, the D1 field can be implemented as follows:
0: Not Defined
1: Diagnosis, DoIP (indicates a diagnostic device)
2: Undefined instruments (indicates a special device)

The D2 field is a field that indicates predetermined connection conditions and can be ignored in the case of DoIP.

The D3 field can correspond to the classification of data in a request that is transmitted externally. Requests for in-vehicle data can follow the COVESA standard, for example. For example, if the speed of the vehicle is required, the format can be as follows:
Speed:
Type: Sensor
Description: The vehicle speed.
comment: For engine speed see Vehicle.Powertrain.CombustionEngine.Engine.Speed.
Datatype: Float
Unit: km/h
min: 0
max: 300

The D4 field can include the actual transmitted content excluding the information recorded in the D1, D2, and D3 fields.

FIG. 8 is a drawing for describing a computing device according to an implementation.

Referring to FIG. 8, the method and the device for connecting the vehicle to the external device according to implementations can be implemented using the computing device 50. The computing device 50 can be implemented as various types of electronic devices, servers, or similar devices, and its function can be implemented through a combination of software and hardware.

The computing device 50 can include at least one of the processor 510, a memory 530, a user interface input device 540, a user interface output device 550, and a storage device 560 communicating through a bus 520. The computing device 50 can also include a network interface 570 electrically connected to a network 40. The network interface 570 can transmit or receive signals to or from other entities through the network 40.

The processor 510 can be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is a semiconductor device that executes instructions stored in the memory 530 or the storage device 560 and can play a key role in the system. Program codes and data stored in the memory 530 or the storage device 560 instruct the processor 510 to perform specific tasks, thereby enabling the overall operation of the system. The processor 510 can be configured to implement various functions and methods described above with respect to FIGS. 1 to 7.

The memory 530 and the storage device 560 can include various forms of volatile or non-volatile storage media for storing and accessing data of the system. For example, the memory 530 can include a read-only memory (ROM) 531 and a random access memory (RAM) 532. In some implementations, the memory 530 can be built into the processor 510, in which case data transmission speeds between the memory 530 and the processor 510 can be very fast. In some other implementations, the memory 530 can be disposed external to the processor 510, in which case the memory 530 can be connected to the processor 510 through various data buses or interfaces. This connection can be made through a variety of known means—for example, a peripheral component interconnect express (PCIe) interface for high-speed data transmission or a memory controller.

In some implementations, at least some of the components or functions of the method and the device for connecting the vehicle to the external device according to the implementations can be implemented as a program or software executed on the computing device 50, and the program or software can be stored on a computer-readable recording medium or storage medium. Specifically, according to an implementation, a computer-readable recording medium or storage medium can record a program for executing steps included in an implementation of the method and the device for connecting the vehicle to the external device according to the implementations, on a computer including the processor 510 executing a program or instructions stored in the memory 530 or the storage device 560.

In some implementations, at least some of the components or functions of the method and the device for connecting the vehicle to the external device according to the implementations can be implemented using hardware or a circuit of the computing device 50, or can be implemented as separate hardware or a circuit that can be electrically connected to the computing device 50.

In some implementations, the computing device 50 is provided with one or more non-transitory computer-readable media including executable instructions, which, when executed by one or more processors of the computing device 50, cause the computing device 50 to perform operations. Here, the operation can include the configuration, function, steps, etc. described in this specification with respect to the method and the device for connecting the vehicle to the external device according to the implementations.

According to implementations, certain data can be provided in an unsecured state through user approval and security authentication procedures. By enabling access to data based on the authorization of the user (e.g., an authorized vehicle owner) after activating the network through the DoIP activation line, it is possible to maintain the security of vehicle data access while increasing user convenience and improving efficiency in the data exchange process.

While the implementations of the present disclosure have been described in detail, it is to be understood that the disclosure is not limited to the disclosed implementations, but on the contrary, is intended to cover various modifications and equivalent arrangements included within the spirit and scope of the appended claims.

What is claimed is:

1. A method for connecting a vehicle to an external device, performed by a computing device implemented in the vehicle and including a processor, a memory device, and a communication interface, the method comprising:
receiving, from a gateway in the vehicle, a first encrypted packet comprising an external device access notification indicating that access by the external device has occurred;
transmitting, to a server, a first signal comprising a connection approval request requesting approval of connection of the external device;
receiving, from the server, a second signal comprising a connection approval response approving the connection of the external device;
generating a second encrypted packet comprising an external device connection process request that allows connection of the external device; and
transmitting, to the gateway in response to the connection approval response, the second encrypted packet comprising the external device connection process request that allows connection of the external device.

2. The method for connecting the vehicle to the external device of claim 1, wherein
the connection approval response is based on approval by a user terminal in response to the connection approval request received from the server.

3. The method for connecting the vehicle to the external device of claim 1, wherein
the first encrypted packet comprising the external device access notification received from the gateway and the second encrypted packet comprising the external device connection process request transmitted to the gateway comprise an Ethernet packet to which media access control security (MACsec) is applied.

4. The method for connecting the vehicle to the external device of claim 3, wherein
the Ethernet packet comprises a security tag (SecTAG) field and an integrity check value (ICV) field.

5. The method for connecting the vehicle to the external device of claim 2, wherein
the user terminal displays a user interface for receiving input from a user to allow connection of the external device,
and the connection approval response is transmitted from the user terminal to the server based on the input from the user through the user interface.

6. The method for connecting the vehicle to the external device of claim 1, further comprising:
receiving, from the gateway, a third encrypted packet comprising a vehicle information connection permission request requesting connection permission for vehicle information by the external device;
transmitting, to the server, a third signal comprising a permission approval request requesting approval of permission of the external device;
receiving, from the server, a fourth signal comprising a permission approval response approving the permission of the external device;
generating a fourth encrypted packet comprising vehicle data; and
transmitting the fourth encrypted packet to the gateway to provide the vehicle data to the external device through the gateway in response to the permission approval response.

7. The method for connecting the vehicle to the external device of claim 6, wherein
the permission approval response is based on approval by a user terminal in response to the permission approval request received from the server.

8. The method for connecting the vehicle to the external device of claim 6, wherein
the third encrypted packet comprising the vehicle information connection permission request received from the gateway and the fourth encrypted packet comprising the vehicle data transmitted to the gateway comprise an Ethernet packet to which media access control security (MACsec) is applied.

9. The method for connecting the vehicle to the external device of claim 7, wherein
the user terminal displays the user interface for receiving input allowing the permission of the external device from the user,
and the permission approval response is transmitted from the user terminal to the server based on the input from the user through the user interface.

10. The method for connecting the vehicle to the external device of claim 1, further comprising:
receiving, from the gateway, a third encrypted packet comprising a vehicle information connection permission request requesting connection permission for vehicle information by the external device;
generating a fourth encrypted packet comprising vehicle data; and
transmitting the fourth encrypted packet to the gateway to provide the vehicle data to the external device through the gateway.

11. The method for connecting the vehicle to the external device of claim 10, wherein
the third encrypted packet comprising the vehicle information connection permission request transmitted from the external device to the gateway and the fourth encrypted packet comprising the vehicle data transmitted from the gateway to the external device comprise an Ethernet packet to which transport layer security (TLS) is applied.

12. The method for connecting the vehicle to the external device of claim 11, wherein
the Ethernet packet comprises a TLS field.

13. A device implemented in a vehicle and configured to connect a vehicle to an external device, the device comprising:
a communication interface;
one or more non-transitory computer-readable media including instructions; and
one or more processors configured to execute the instructions to perform operations comprising:
receiving, from a gateway in the vehicle, a first encrypted packet comprising an external device access notification indicating that access by the external device has occurred;
transmitting, to a server, a first signal comprising a connection approval request requesting approval of connection of the external device;
receiving, from the server, a second signal comprising a connection approval response approving the connection of the external device;
generating a second encrypted packet comprising an external device connection process request that allows connection of the external device; and
transmitting, to the gateway in response to the connection approval response, the second encrypted packet comprising the external device connection process request that allows connection of the external device.

14. The device of claim 13, wherein
the connection approval response is based on approval by a user terminal in response to the connection approval request received from the server.

15. The device of claim 13, wherein
the first encrypted packet comprising the external device access notification received from the gateway and the second encrypted packet comprising the external device connection process request transmitted to the gateway comprise an Ethernet packet to which media access control security (MACsec) is applied.

16. The device of claim 13, wherein
the operation further comprises:
receiving, from the gateway, a third encrypted packet comprising a vehicle information connection permission request requesting connection permission for vehicle information by the external device;
transmitting, to the server, a third signal comprising a permission approval request requesting approval of permission of the external device;
receiving, from the server, a fourth signal comprising a permission approval response approving the permission of the external device;
generating a fourth encrypted packet comprising vehicle data; and
transmitting the fourth encrypted packet to the gateway to provide the vehicle data to the external device through the gateway in response to the permission approval response.

17. The device of claim 16, wherein
the permission approval response is based on approval by the user terminal in response to the permission approval request received from the server.

18. The device of claim 13, wherein the operations further comprise:
receiving, from the gateway, a third encrypted packet comprising a vehicle information connection permission request requesting connection permission for vehicle information by the external device;
generating a fourth encrypted packet comprising vehicle data; and
transmitting the fourth encrypted packet to the gateway to provide the vehicle data to the external device through the gateway.

19. The device of claim 18, wherein
the third encrypted packet comprising the vehicle information connection permission request transmitted from the external device to the gateway and the fourth encrypted packet comprising the vehicle data transmitted from the gateway to the external device comprise an Ethernet packet to which transport layer security (TLS) is applied.

20. One or more non-transitory computer-readable media, comprising instructions that, based on being executed by a computing device in a vehicle comprising a communication interface, cause the computing device to perform operations comprising:
receiving, from a gateway in the vehicle, a first encrypted packet comprising an external device access notification indicating that access by an external device has occurred;
transmitting, to a server, a first signal comprising a connection approval request requesting approval of connection of the external device;
receiving, from the server, a second signal comprising a connection approval response approving the connection of the external device;
generating a second encrypted packet comprising an external device connection process request that allows connection of the external device; and
transmitting, to the gateway in response to the connection approval response, the second encrypted packet comprising the external device connection process request that allows connection of the external device.
